(19) United States
(12) Patent Application Publication
(10) Pub. No.: US 2005/0239633 A1
(43) Pub. Date: Oct. 27, 2005

(54) Control method of catalyst activity

(76) Inventors: Hajime Kabashima, Saitama (JP); Jun Iwamoto, Saitama (JP); Masaru Oku, Saitama (JP)

Correspondence Address: ARENT FOX PLLC, 1050 CONNECTICUT AVENUE, N.W., SUITE 400, WASHINGTON, DC, 20036, US

(21) Appl. No.: 11/081,846

(22) Filed: Mar. 17, 2005

(30) Foreign Application Priority Data
Mar. 17, 2004 (JP) 2004-075941

(51) Int. Cl. B01J 38/12

(52) U.S. Cl. 502/38

(57) ABSTRACT

The invention provides a method able to remove coke and an unreacted component deposited in an active spot on the surface of a catalyst and restore reduced catalyst activity to efficiently reform fuel for an automobile for a long time. The catalyst activity can be approximately perfectly restored by burning-off the coke and the unreacted component deposited on the surface of the catalyst by using oxygen enrichment air.

### CROSS-REFERENCE TO RELATED APPLICATIONS

This application is based upon and claims the benefit of priority from the prior Japanese Patent Application No. 2004-075941 filed on Mar. 17, 2004, the entire contents of which is incorporated herein by reference.

### FIELD OF THE INVENTION

The present invention relates to a method for controlling catalyst activity in a reforming reaction of automobile fuel using a catalyst.

### BACKGROUND OF THE INVENTION

Hydrogen energy is clean energy and its future utilization is expected as an energy source such as a fuel cell, an internal combustion engine, etc. With respect to the internal combustion engine, researches with respect to a hydrogen engine, a hydrogen addition engine, de-NOx with hydrogen as a reducer, etc. are made. Further, with respect to the supply of hydrogen as a raw material of the fuel cell, a research development about a manufacturing method of hydrogen using fuel reforming is vigorously performed.

Various kinds of catalysts are used in the above fuel reforming. However, when the reforming reaction is continuously performed, the disadvantage that a carbonaceous material called coke is deposited and accumulated on the surface of the catalyst and the number of effective active spots is reduced is caused. This means a reduction in the catalyst activity, i.e., a reduction in reaction efficiency. Therefore, this disadvantage becomes a great obstacle in realizing the efficient manufacture of hydrogen. The deposition of the coke on the surface of the catalyst is caused in many cases by firmly adsorbing a reaction raw material or a formed substance onto the surface of the catalyst and performing polymerization and a dehydrogenation reaction. Therefore, it is necessary to weaken the catalyst activity from the viewpoint of deposition prevention of the coke. However, as the catalyst activity is weakened, a reaction velocity is reduced so that no efficient reforming reaction can be performed. This is contrary to an object of the catalyst development of obtaining a maximum reaction velocity by a small amount of catalyst or a compact catalyst reactor. Namely, the catalyst activity must be sacrificed to a certain extent so as to prevent deterioration of the catalyst. Where this balance is made depends on the kind of the reaction raw material or a catalyst system (see Non-Patent Document 1: pp. 174-184 of “Advance of Chemical Engineering, 29-th collection, Catalyst Engineering” (first issue) edited by Tohkai Branch of Corporation Chemical Engineering Society of Japan and published by Maki-Shoten, Nov. 20, 1995).

For example, when diesel fuel is reformed under the existence of a carrying Rh catalyst system, not a little coking is generated on the catalyst even when a steam reforming method (SR method), a partial oxidation reforming method (CPO method) or an auto thermal reforming method (ATR method) combining the steam reforming method and the partial oxidation reforming method is used. The activity deterioration of the catalyst due to the deposition and accumulation of the coke is reversible activity deterioration in which the activity is restored if the coke is combusted. However, when a fixed bed flow reactor is used, etc., its processing is difficult (see Non-Patent Document 1).

Therefore, the development of the catalyst causing no coking, consideration of a reaction condition, etc. are performed so as to restrain the deposition of the coke on the catalyst surface. No catalyst causing no coking has been developed yet. However, high dispersion formation of a metal (see Non-Patent Document 2: C. H. Bartholomew, “Catal. Rev.-Sci Eng.”, 24 67 (1982)), usage of a basic carrier (see Non-Patent Document 3: O. Yamazaki, T. Nozaki, K. Omata, K. Fujimoto, “Chem. Lett.”, 1953, (1992)), etc. are considered as another approach for restraining the coking. Further, the adoption of a method for supplying a surplus amount of oxidizer (steam, oxygen and air) to the reactor is considered as the reaction condition for restraining the coking. However, when the steam is superfluously supplied, thermal efficiency is reduced and more energy is required to obtain hydrogen. When oxygen is superfluously supplied, the yield of hydrogen is reduced due to excessive combustion. Further, when a surplus amount of oxidizer is supplied, an unreacted oxidizer must be separated and recovered from hydrogen. Accordingly, no method able to effectively prevent the deposition of the coke on the catalyst surface and control efficiency of the reforming reaction is established in the present situation.

With respect to this, the reforming reaction can be sufficiently performed even in the small amount of catalyst and the compact reactor if all the coke deposited on the surface of the catalyst can be simply removed and the catalyst activity can be approximately perfectly restored. Accordingly, the establishment of the removing method of the coke deposited on the catalyst surface is useful since hydrogen can be simply utilized for the fuel cell and the internal combustion engine and this establishment also contributes to the effective utilization of natural resources including hydrogen.

### SUMMARY OF THE INVENTION

The present invention is made in consideration of the above problems, and its object is to provide a method able to remove the coke and the unreacted component deposited in the active spot on the catalyst surface and restore the reduced catalyst activity to efficiently reform the fuel for an automobile for a long time.

The present inventors earnestly and repeatedly made researches to solve the above problems. As its result, the present inventors have found that the catalyst activity can be approximately perfectly restored by burning-off the coke and the unreacted component deposited on the surface of the catalyst using oxygen enrichment air. Thus, the present invention has been completed. More concretely, the present invention provides the following method.

(1) A control method of catalyst activity in a reforming reaction of automobile fuel using a catalyst, comprising the step of:
restraining deterioration of the catalyst by burning off coke and an unreacted component deposited on the surface of said catalyst by said reforming reaction under the existence of oxygen enrichment air.

(2) The control method of the catalyst activity according to (1), wherein the volume % of oxygen within said oxygen enrichment air is set to 25% or more and is also set to be less than 100%.

(3) The control method of the catalyst activity according to (1) or (2), wherein said reforming reaction is set to at least one kind of reaction selected from a group consisting of a steam reforming reaction, a partial oxidizing reaction, and an auto thermal reforming reaction combining the steam reforming reaction and the partial oxidizing reaction.

(4) The control method of the catalyst activity according to any one of (1) to (3), wherein said reforming reaction is performed under the atmosphere of the air, oxygen and steam.

(5) The control method of the catalyst activity according to any one of (1) to (4), wherein said reforming reaction is continuously performed.

According to the present invention, the catalyst activity reduced by the reforming reaction can be approximately perfectly restored and the fuel for an automobile can be efficiently reformed for a long time and hydrogen can be efficiently manufactured. Further, the following effects are recognized. Firstly, activity deterioration of the catalyst can be restrained since accumulation of the coke in the active spot on the catalyst surface is reduced. Secondly, since the coke can be perfectly removed, a pressure loss of the catalyst can be restrained and LHSV (liquid hourly space velocity=spatial velocity of fuel per one hour) can be increased. Thirdly, the using amount of the catalyst can be reduced since the catalyst deterioration can be restrained and duration of the catalyst activity can be increased. Since the used catalyst amount can be reduced, the using amount of a noble metal can be reduced and cost can be reduced. Further, it is possible to design a compact reactor. Fourthly, since the coke can be perfectly removed even when the coke is deposited, it is not necessary to supply a surplus amount of oxidizer (steam, oxygen and air) to a reactor. For example, the present invention solves the problem that thermal efficiency is reduced and more energy is required to obtain hydrogen when the steam is superfluously supplied. The present invention also solves the problem that hydrogen yield is reduced due to excessive combustion when oxygen is superfluously supplied. The present invention also solves the problem that the unreacted oxidizer must be separated and recovered from hydrogen when the surplus amount of oxidizer is supplied.

### BRIEF DESCRIPTION OF THE DRAWINGS

FIG. 1 is a schematic constructional view of a typical hydrogen manufacturing device of a continuous type used in the present invention.

FIG. 2 is a view showing durability of catalysts in an embodiment and a comparison example.

### DETAILED DESCRIPTION OF THE PREFERRED EMBODIMENT

An embodiment mode of the present invention will next be explained with reference to the drawings.

[Raw Material]

The present invention relates to a method for controlling catalyst activity in a reforming reaction of automobile fuel using a catalyst. A hydrocarbon group such as gasoline, diesel fuel, natural gas, propane gas, alcohol, bio-diesel, etc. is used as the automobile fuel used in the present invention. This hydrocarbon group includes an alkane group, an alkene group, an alkyne group, an aromatic compound, etc.

Air, oxygen, steam, etc. are used as a reforming agent used in the reforming of the automobile fuel. Rainwater, city water, primarily processed drainage, etc. can be utilized as the steam in addition to pure water. Further, in the present invention, it is characterized in that the catalyst is burned off by using oxygen enrichment air. The oxygen enrichment air means the air in which oxygen is rich. Concretely, a preferable oxygen concentration lies within a range which is 25% or more and is less than 100% in volume %. A further preferable oxygen concentration lies within a range of 30% to 60% in volume %. A most preferable oxygen concentration lies within a range of 35% to 45% with a concentration near 40% as a center.

Further, the reforming reaction of the automobile fuel in the present invention is performed by using the catalyst. A general catalyst can be used as the catalyst. For example, a partial oxidizing catalyst Rh/Al₂O₃, etc. can be used in the reforming using a partial oxidizing reaction. In accordance with a conventional publicly known method, this partial oxidizing catalyst Rh/Al₂O₃ can be obtained by adding γAl₂O₃ to a nitric acid Rh aqueous solution and then performing deposition and precipitation.

[Hydrogen Manufacturing Device]

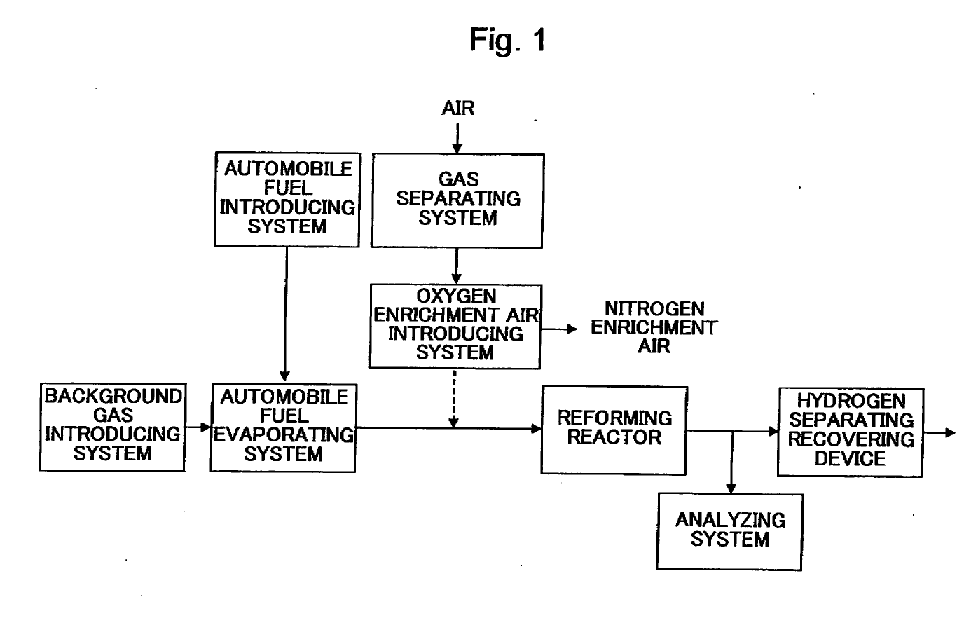

The reforming reaction performed in the present invention can be performed in any one of a batch type and a continuous type. Therefore, all conventional publicly known devices can be used as a reforming reactor, and there is not particular limit in this reforming reactor. For example, a fixed bed flow reactor, a batch type reactor, etc. can be used. However, in the present invention, the reforming reaction using the catalyst can be stably performed and no yield of hydrogen is reduced so much even when reaction gas is continuously supplied to the reforming reactor. Accordingly, the continuous type is preferably adopted. FIG. 1 shows a schematic constructional view of a typical hydrogen manufacturing device of the continuous type used in the present invention. This hydrogen manufacturing device is mainly constructed by an automobile fuel introducing system for introducing the automobile fuel, a background gas introducing system for introducing background gas, an automobile fuel evaporating system for evaporating the automobile fuel, a gas separating system used to obtain the oxygen enrichment air from the air, an oxygen enrichment air introducing system for introducing the oxygen enrichment air obtained by the gas separating system, a reforming reactor for reforming the automobile fuel under the existence of the oxygen enrichment air, a hydrogen separating-recovering device for separating and recovering hydrogen obtained by the reforming reaction, and an analyzing system for making the analysis of generated gas obtained by the reforming reaction. All conventional publicly known films can be used in a gas separating film used in the gas separating system, and there is no particular limit in this gas separating film. For example, polyimide hollow yarn, a polydimethyl siloxane flat film, etc. are used.

Concretely, the automobile fuel is mixed with the background gas, and is controlled by a gas flow rate control system having a flow meter through a stop valve, a flow control valve, etc. and is then introduced into the reforming reactor. The introduced mixing gas is reformed by this reforming reactor and gas including hydrogen is generated. Components of the generated gas including hydrogen are then analyzed by the analyzing system having the gas chromatography, etc. The generated gas is sent to the hydrogen separating-recovering device and hydrogen as an object is recovered. Gases except for hydrogen are processed by an exhaust gas processing system.

The catalyst is burned off by continuously performing the reforming reaction for a constant time and then once stopping the supply of a raw material gas and supplying the oxygen enrichment air. The burn-off means combustion removal, and is that coke, etc. deposited on the catalyst are completely burned under an oxygen rich condition. After the burn-off is terminated, the supply of the oxygen enrichment air is stopped and the supply of the raw material gas is started and the reforming reaction is restarted.

[Reforming Reaction]

In the present invention, the reforming reaction can be also performed by directly introducing the automobile fuel into the reforming reactor. However, it is more preferable to introduce the automobile fuel into the reforming reactor after the automobile fuel is evaporated to the background gas such as the air, etc. When the air is used as the background gas, it is preferable to set the weight ratio of the air and the fuel within the range of an A/F ratio=1 to 20. When the concentration of oxygen within the background gas is excessively high, it is not preferable since hydrogen generated in the reforming reaction is oxidized and changed into water and the recovery percentage of hydrogen gas is reduced.

The A/F ratio can be suitably adjusted by adjusting the gas flow rate. For example, when reforming using a partial oxidizing reaction is performed, the concentration of the automobile fuel is raised and the gas flow rate is Increased within the oxygen concentration range causing the partial oxidizing reaction to optimize the generated hydrogen amount per unit time. The automobile fuel is mixed into the background gas such that the A/F ratio preferably lies within a range of 1 to 20, and more preferably lies within a range of 2 to 10, and most preferably lies within a range of 4 to 8 with a value near the A/F ratio=about 6 as a center. The reaction pressure is not particularly limited, but is preferably one atmospheric pressure as normal pressure.

The reforming reaction in the present invention can be executed in a reaction temperature area from 500° C. to about 900° C., and the concentration of hydrogen can be adjusted by the vapor pressure of a generated product using the reforming. Further, in a manufacturing method of hydrogen from the automobile fuel of the present invention, CO, CO₂, and a hydrocarbon group are generated in addition to hydrogen.

### EMBODIMENT

The present invention will next be explained in detail on the basis of an example, but the present invention is not limited to this example.

### EXAMPLE

The reforming using the partial oxidizing reaction of diesel fuel was performed and coke and an unreacted component deposited on the catalyst surface by this reforming reaction were burned off by using the oxygen enrichment air. The hydrogen manufacturing device of the continuous type was used as a hydrogen manufacturing device, and a partial oxidizing catalyst Rh/Al₂O₃ was used as the catalyst.

[Preparation of Partial Oxidizing Catalyst Rh/Al₂O₃]

[Preparation of γAl₂O₃]

About 100 g of prepared γAl₂O₃ (AKP-G30LA manufactured by Sumitomo Kagaku Co., Ltd.) was suspended to 200 mL of super pure water within a beaker for storing 500 mL. A stirrer piece manufactured by Teflon (registered trademark) was put into the suspended solution, and was slowly agitated for several minutes at room temperature by a magnetic stirrer with a hot plate. After the agitation, water was removed and the above operation was repeated three times. γAl₂O₃ performed three times with respect to the above operation was covered with a cover such that no dust enters this γAl₂O₃. Vacuum drying was then performed at 80° C. in one night and water was removed. After the drying, γAl₂O₃ was transfused to a storing container and was stored in a desiccator until use.

[Adjustment (Deposition Precipitation Method) of Rh/Al₂O₃]

Powder of the dried γAl₂O₃ was weighed by 25 grams. In contrast to this, nitric acid rhodium [Rh(NO₃)₃] was weighed so as to have 2% in weight percentage as a rhodium metal.

[Catalyst Carry]

γA₂O₃, 350 mL of super pure water and organic alkali [N(CH₃)40H.5H₂O] were put Into a three-neck flask for storing 500 mL, and were agitated, heated and changed into slurry at 60° C. While the nitric acid rhodium set to an aqueous solution was held at the temperature of 60° C., this nitric acid rhodium was slowly added in the three-neck flask for storing 500 mL little by little. After the nitric acid rhodium aqueous solution was added, the mixture was agitated for one hour at 60° C. Water was removed from the slurry and the mixture was put Into an oven of 100° C. for 12 hours and was dried and solidified. The dried and solidified catalyst was put into an electric furnace of 500° C. for four hours and was burned.

[Reforming Reaction Condition]

LHSV (liquid hourly space velocity=spatial velocity of fuel per one hour) with respect to the catalyst preferably lies within a range of 0.5 h⁻¹ to 20 h⁻¹, and LHSV=2.3 was set in this embodiment. The air was used as the background gas, and the weight ratio of the air and the diesel fuel was set to an A/F ratio=4. Further, the reforming was performed at a reaction temperature 800° C. A quantitative analysis was made by using GC (GC-390B manufactured by GL Science, Unipack S) having FID (hydrogen flame Ionization detector) as a detector with respect to an organic compound. Further, the quantitative analysis of hydrogen was made by using GC (GC-390B manufactured by Shimadzu, MS-5A) having TCD (thermal conductivity detector) as a detector.

[Burn-Off]

After the reforming using the partial oxidizing reaction of the diesel fuel was performed, coke and an unreacted component deposited on the catalyst surface by this reforming reaction were burned off by using the oxygen enrichment air having 40% in volume % concentration of oxygen. Concretely, when the burn-off was performed, the burn-off was executed by supplying the oxygen enrichment air after the reforming reaction was interrupted by once stopping the supply of a raw material gas. Further, after the burn-off was terminated, the supply of the oxygen enrichment air was stopped. Instead of this, the supply of the raw material gas was started and the reforming reaction was restarted. This operation was repeatedly executed and the change of yield of hydrogen was examined.

### COMPARISON EXAMPLE

As a comparison example, the coke and the unreacted component deposited on the catalyst surface were burned off by using the normal air having 21% in volume % concentration of oxygen. The used hydrogen manufacturing device, the catalyst, the reforming reaction condition, etc. were set similarly to the embodiment except that the oxygen concentration of the air used in the burn-off was small in comparison with the embodiment.

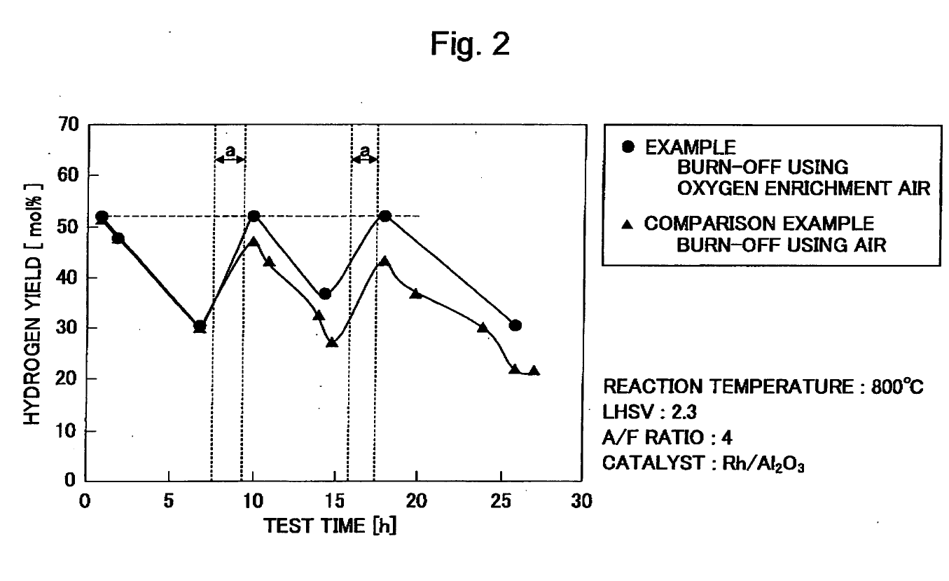

FIG. 2 shows changes of the yield of hydrogen in the embodiment and the comparison example. As shown in FIG. 2, the coke and the unreacted component were deposited in an active spot on the catalyst surface and the number of effective active spots was reduced with the passage of test time (reacting time) from the start of the reforming reaction. Therefore, the yield of hydrogen was reduced. The burn-off was performed to remove these deposited coke and unreacted component. Thus, the yield of hydrogen was improved in each of the embodiment and the comparison example. This shows that the coke and the unreacted component accumulated in the active spot on the catalyst surface were removed by the burn-off and the active spot was restored. In the comparison example, no hydrogen yield was restored until the original level. In contrast to this, in the embodiment, the yield of hydrogen was approximately perfectly restored by the burn-off. This means that the coke and the unreacted component cannot be perfectly burned off by only the normal air.

When the reforming reaction was restarted after the termination of the burn-off, the coke and the unreacted component were again deposited on the catalyst surface and the yield of hydrogen was reduced. In the comparison example, the coke, etc. were added and further accumulated to the coke, etc. unremoved and left by the burn-off of the first time. Therefore, the yield of hydrogen was further reduced. Moreover, the yield of hydrogen was not restored to the original level, and also to the level after the burn-off of the first time by the burn-off of the second time, in contrast to this, in the embodiment, the yield of hydrogen can be restored until the original level by the burn-off of the second time. Thus, it shows the present invention, i.e. that the catalyst activity is approximately perfectly restored and hydrogen can be efficiently manufactured by burning-off the coke and the unreacted component deposited in the active spot on the catalyst surface by using the oxygen enrichment air. In this embodiment, the yield of hydrogen can be continuously restored to the original level over 50 hours. Accordingly, it has been confirmed that a stable continuous operation can be performed for a long time.

1. A control method of catalyst activity in a reforming reaction of automobile fuel using a catalyst, comprising the step of:
restraining deterioration of the catalyst by burning off coke and an unreacted component deposited on the surface of said catalyst by said reforming reaction under the existence of oxygen enrichment air.

2. The control method of the catalyst activity according to claim 1, wherein the volume % of oxygen within said oxygen enrichment air is set to 26% or more and is also set to be less than 100%.

3. The control method of the catalyst activity according to claim 1, wherein said reforming reaction is set to at least one kind of reaction selected from a group consisting of a steam reforming reaction, a partial oxidizing reaction, and an auto thermal reforming reaction combining the steam reforming reaction and the partial oxidizing reaction.

4. The control method of the catalyst activity according to claim 2, wherein said reforming reaction is set to at least one kind of reaction selected from a group consisting of a steam reforming reaction, a partial oxidizing reaction, and an auto thermal reforming reaction combining the steam reforming reaction and the partial oxidizing reaction.

5. The control method of the catalyst activity according to claim 1, wherein said reforming reaction is performed under the atmosphere of the air, oxygen and steam.

6. The control method of the catalyst activity according to claim 2, wherein said reforming reaction is performed under the atmosphere of the air, oxygen and steam.

7. The control method of the catalyst activity according to claim 3, wherein said reforming reaction is performed under the atmosphere of the air, oxygen and steam.

8. The control method of the catalyst activity according to claim 4, wherein said reforming reaction is performed under the atmosphere of the air, oxygen and steam.

9. The control method of the catalyst activity according to claim 1, wherein said reforming reaction is continuously performed.

10. The control method of the catalyst activity according to claim 2, wherein said reforming reaction is continuously performed.

11. The control method of the catalyst activity according to claim 3, wherein said reforming reaction is continuously performed.

12. The control method of the catalyst activity according to claim 4, wherein said reforming reaction is continuously performed.

13. The control method of the catalyst activity according to claim 5, wherein said reforming reaction is continuously performed.

14. The control method of the catalyst activity according to claim 6, wherein said reforming reaction is continuously performed.

15. The control method of the catalyst activity according to claim 7, wherein said reforming reaction is continuously performed.

16. The control method of the catalyst activity according to claim 8, wherein said reforming reaction is continuously performed.
